(19) United States
(12) Patent Application Publication
(10) Pub. No.: US 2022/0244859 A1
(43) Pub. Date: Aug. 4, 2022

(54) DATA TRANSMISSION METHOD

(71) Applicant: ATEN INTERNATIONAL CO., LTD., New Taipei City (TW)

(72) Inventors: Chia-Chang Hsu, New Taipei City (TW); Bo-Jyun Chen, New Taipei City (TW)

(73) Assignee: ATEN INTERNATIONAL CO., LTD., New Taipei City (TW)

(21) Appl. No.: 17/574,570

(22) Filed: Jan. 13, 2022

(30) Foreign Application Priority Data
Feb. 1, 2021 (TW) 110103694

(51) Int. Cl. G06F 3/06

(52) U.S. Cl. CPC G06F 3/067; G06F 3/0604; G06F 3/065

(57) ABSTRACT

A data transmission method, applied to a data transmission device connected to a first host and a second host, comprising: (a) activating a console of the first host via a trigger operation and acquiring a source path of target data in the first host; (b) acquiring the target data from the source path and copying the target data to a storage circuit inside or outside the data transmission device; and (c) copying the target data from the storage circuit to the second host.

### BACKGROUND OF THE INVENTION

### 1. Field of the Invention

The present invention relates to a data transmission method, and particularly relates to a data transmission method which can transmit data between different computers without a network.

### 2. Description of the Prior Art

In some situations, the user may use different connected hosts (e.g., computers) to form a complicated data processing system. Under such architecture, the user may need to perform data transmission between different hosts. A conventional data transmission method needs connecting the hosts to a network for data exchanging. However, if no network is provided, conventional storage media such as a flash or an optical disc is needed for data exchanging. Therefore, the user may feel inconvenient.

### SUMMARY OF THE INVENTION

Therefore, one objective of the present invention is to provide a data transmission method which allows different hosts to exchange data without using a network, and can use a simple architecture which allows different hosts to exchange data while using the network.

One embodiment of the present invention discloses a data transmission method, applied to a data transmission device connected to a first host and a second host, comprising: (a) activating a console of the first host via a trigger operation and acquiring a source path of target data in the first host; (b) acquiring the target data from the source path and copying the target data to a storage circuit inside or outside the data transmission device; and (c) copying the target data from the storage circuit to the second host.

In view of above-mentioned embodiments, the data transmission method and the data transmission device provided by the present invention can allow different hosts to exchange data without using a network, and can use a simple architecture which allows different hosts to exchange data while using the network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a data transmission device according to one embodiment of the present invention.

FIG. 2 is a flow chart illustrating a data transmission method according to one embodiment of the present invention.

FIG. 3 and FIG. 4 are schematic diagrams illustrating a data transmission method according to one embodiment of the present invention.

FIG. 5 is a flowchart illustrating how to acquire a source path and to activate a console, according to one embodiment of the present invention.

FIG. 6 is a detail flow chart illustrating a data transmission method according to one embodiment of the present invention.

FIG. 7 and FIG. 8 are examples of practical application according to different embodiments of the present invention.

### DETAILED DESCRIPTION

Several embodiments are provided in following descriptions to explain the concept of the present invention. Each component in following descriptions can be implemented by hardware (e.g. a device or a circuit) or hardware with software (e.g. a program installed to a processor). Besides, the method in following descriptions can be executed by programs stored in a non-transitory computer readable recording medium such as a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices.

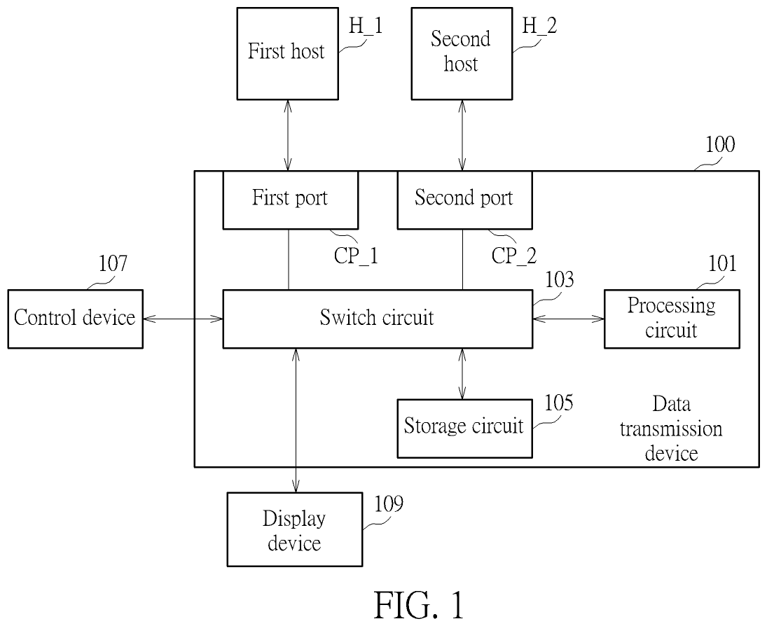

FIG. 1 is a block diagram illustrating a data transmission device according to one embodiment of the present invention. As illustrated in FIG. 1, the data transmission device 100 comprises a processing circuit 101, a switch circuit 103, a storage circuit 105, a first port CP_1 and a second port CP_2. The switch circuit 103 is connected to a control device 107 and a display device 109. The first port CP_1 and the second port CP_2 are respectively connected to a first host H_1 and a second host H_2. The processing circuit 101 can be, for example, a central processing unit (CPU), a microcontroller (MCU) or other components or chips with data processing and computing capabilities. Also, the switch circuit 103 can be, for example, a circuit or a chip with selectable transmission paths such as a switch or a multiplexer. Please note, however, the data transmission device of the present invention is not limited to the structures and connections shown in FIG. 1. Any structure and connection that can achieve the same functions should fall in the scope of the present invention. Please note the storage circuit in the present invention can mean a memory or a conventional storage device such as an optical disc or a hard disk.

The control device 107 can receive the user's input and send a control command to the switch circuit 103 to change the connection path of the switch circuit 103, so that the user can control the first host H_1 or the second host H_2. The control device 107 can also receive user inputs to make at least one of the first host H_1, the second host H_2, the processing circuit 101, the storage circuit 105, and the display device 109 perform corresponding operations. The control device 107 can be any type of input device, such as a mouse, a keyboard, a voice input device, a touch pad, a touch control display . . . etc. The storage circuit 105 can be any type of storage component, such as a memory, a hard disk . . . etc. The storage circuit 105 can be provided inside or outside the data transmission device 100. The display device 109 can be any electronic device with a display function, such as a display. The first host H_1 and the second host H_2 may respectively have a dedicated processing circuit and a dedicated storage circuit. For example, the first host H_1 and the second host H_2 may be two different computer hosts. The first port CP_1 and the second port CP_2 can be any type of connection interface, such as an HDMI (High Definition Multimedia Interface) interface or a USB interface.

In following embodiments, the first host H_1 and the second host H_2 are two different computer hosts, and the display device 109 is independent from the first host H_1 and the second host H_2. For example, the first host H_1 and the second host H_2 are two different computer hosts, and the display device 109 is an independent display, but the present invention is not limited to this arrangement. The control device 107 and the display device 109 can be integrated into a notebook. Also, the first host H_1 and the second host H_2 can also be notebooks.

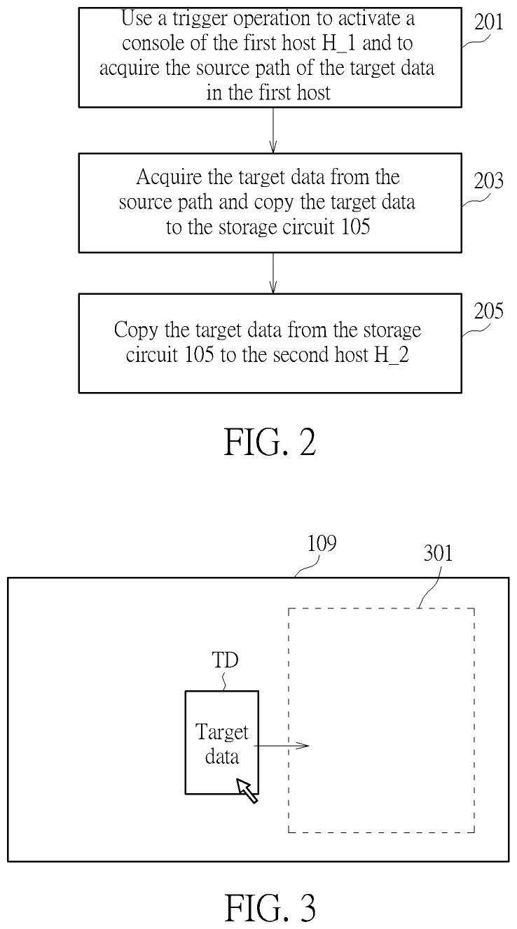

FIG. 2 is a flow chart illustrating a data transmission method according to one embodiment of the present invention, which is used by the data transmission device 100 in FIG. 1 and comprises following steps. The steps can be performed by other devices, units or circuits which are controlled by the processing circuit 101.

### Step 201

Use a trigger operation to activate a console of the first host H_1 and to acquire the source path of the target data in the first host. The target data can be any type of data, such as files, folders, bits, and bytes.

### Step 203

Acquire the target data from the source path and copy the target data to the storage circuit 105.

### Step 205

Copy the target data from the storage circuit 105 to the second host H_2.

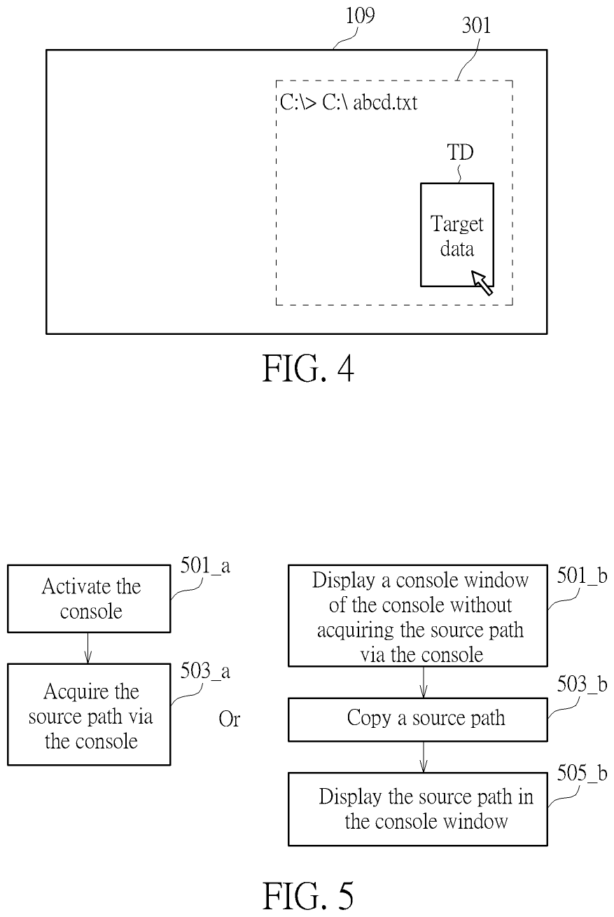

FIG. 3 and FIG. 4 are schematic diagrams illustrating a data transmission method according to one embodiment of the present invention. Please refer to FIG. 1-FIG. 4 at the same time to understand the concept of the present invention for more clarity. In the embodiment of FIG. 3, the host controlled by the data transmission device 100 is the first host H_1, so the display device 109 displays the screen generated by the first host H_1. In the embodiment of FIG. 3, a trigger region 301 is displayed by the display device 109, and the trigger step in the step 201 of FIG. 2 is: drag the target data TD to the trigger region 301 to activate the console. For example, the user can drag the target data TD to the trigger region 301 to activate the console, by a mouse. The trigger region 301 can be presented in any form, such as a region in the displayed screen of the display device, the boundary of the displayed screen of the display device, a window, a region with at least one specific color or a specific pattern, or a region circled by lines. However, please note that the trigger step in step 201 of FIG. 2 is not limited to the embodiment shown in FIG. 3. For example, the trigger step can be any specific command or a combination of commands generated via the control device 107.

In one embodiment, the trigger region 301 is a console window corresponding to the console. Also, the console is activated and the source path of C:\>C:\abcd.txt of the target data TD is displayed, after the user drags the target data TD to the trigger region 301. Please note that the source path C:\>C:\abcd.txt is only an example. In one embodiment, if the user does not disable the drag of the target data TD (for example, still pressing the left button of the mouse), and drags the target data TD out from the trigger region 301, the target data TD is not be copied. If the user drags the target data TD to the trigger region 301 and then disables the drag (for example, releases the left button of the mouse), the target data TD is acquired via the source path C:\>C:\abcd.txt and copied to the storage circuit 105.

After the target data TD is copied to the storage circuit 105, the target data TD can be copied to the second host H_2. This copy operation can be automatically performed by the processing circuit 101, or manually performed by the user. In one embodiment, after the target data is copied to the storage circuit 105 but before the target data TD is copied to the second host H_2, the switch circuit 103 switches the control to the second host H_2. That is, in such case, the user controls the second host H_2 via the control device 107 rather than controls the first host H_1, and the display device 109 displays the screen generated by the second host H_2 rather than the screen generated by the first host H_1.

Since the target data TD is copied via activating the console, the above-mentioned operations can be performed via the operating system (OS) used by the first host H_1, without using any other software. The operating system described here may vary depending on the type of the first host H_1, for example, it may be windows or linux used by a computer, or an operating system of a mobile electronic device such as android and IOS.

In one embodiment, after the target data TD is copied to the storage circuit 105 and switched by the switch circuit 103, the processing circuit 101 can automatically copy the target data TD from the storage circuit 105 to the switched current host. Alternatively, after switch, the user may manually copy the target data from the storage circuit 105 to the current host. In other embodiments, more than one trigger regions can also be used to copy the target data TD to the required host. For example, when the target data is to be copied from the first host to the third host, the target data can be copied to the storage circuit by dragging the target data to the corresponding trigger region. Then, the processing circuit 101 automatically copies the target data TD to the host corresponding to the current trigger region.

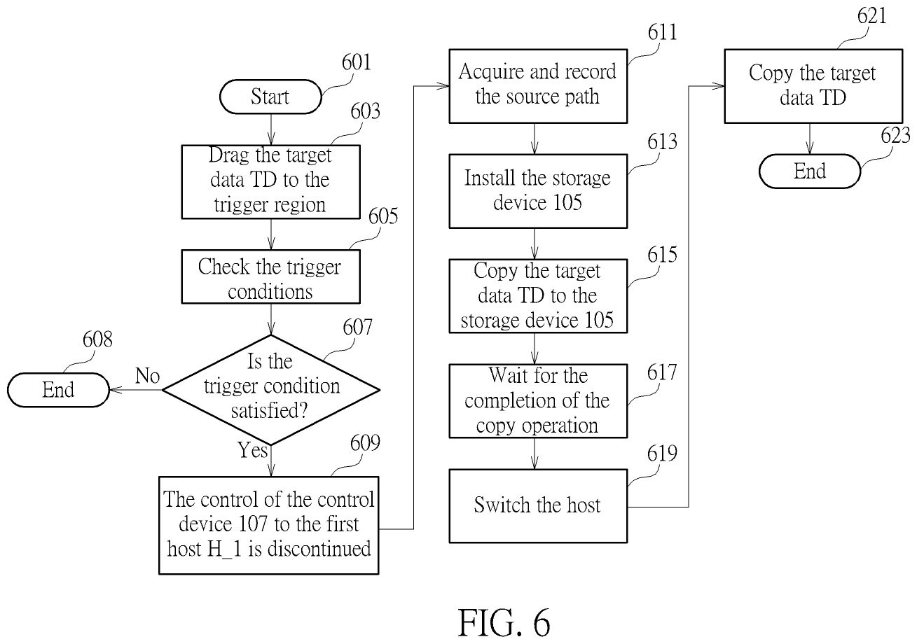

The above-mentioned steps of “activating the console and acquiring the source path of target data in the first host” in FIG. 2 may have a different order. FIG. 5 is a flow chart illustrating how to acquire a source path and to activate a console, according to one embodiment of the present invention. The flowchart on the left side which comprises steps 501_a and 503_a is one embodiment, and the flow chart on the right side which comprises steps 501_b and 503_b is another embodiment.

As shown in FIG. 5, the flowchart on the left side comprises following steps:

### Step 501_a

Activate the console.

### Step 503_a

Acquire the source path via the console, such as the steps shown in the embodiment of FIG. 3 and FIG. 4.

The flowchart on the right side of FIG. 5 comprises following steps:

### Step 501_b

Display a console window of the console without acquiring the source path via the console.

A variety of methods can be used to acquire the source path without using the console. For example, the user can click on the file to be copied and press a specific key or a key combination, and then an option for the copy source path appears. In one embodiment, take Windows as an example, when the user clicks on the file to be copied on the desktop and presses shift+right key, the copy source path option appears. Then the user can copy the source path via the corresponding hot key or directly click on it with the mouse. After copy the source path, the user can trigger the console with other commands, and then paste the copied source path to the console.

### Step 503_b

Copy a source path.

### Step 505_b

Display the source path in the console window.

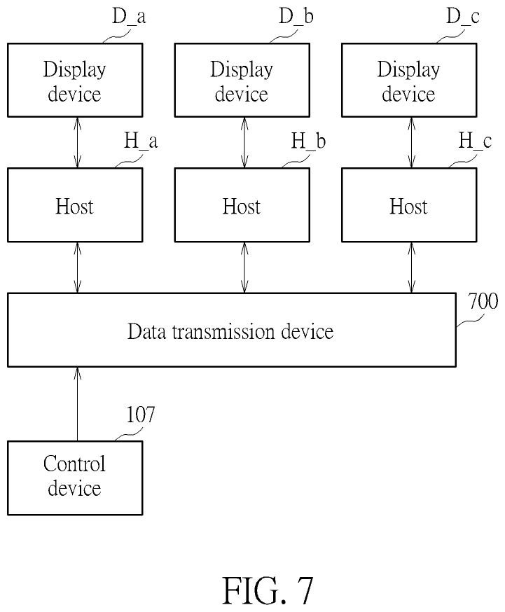

In view of the above-mentioned embodiments, the data transmission device 100 described in FIG. 1 can have a variety of different combinations of operations. FIG. 6 is a detail flow chart illustrating a data transmission method according to one embodiment of the present invention, which comprises following steps:

### Step 601

Start the process of transmitting the target data TD.

### Step 603

The user drags the target data TD to the trigger region (for example, the trigger region 301 described in FIG. 3).

### Step 605

Check the trigger conditions. For example, check whether the user disables the drag action or not.

### Step 607

Determine if the trigger condition is satisfied. If it is not satisfied, go to step 608 to end the process. For example, if the user does not disable the drag operation and drags the target data TD out from the trigger region 301, the process of transmitting the target data ends. If it is satisfied, go to step 609. For example, if the user drags the target data to the trigger region and then disables the dragging action, the process enters the step 609.

### Step 609

In step 609, before acquiring the source path, the control of the control device 107 to the first host H_1 is discontinued to prevent the user from interfering the copy operation of the target data TD. For example, if the control device 107 is an input interface such as a mouse or a keyboard, any input made by the user to the control device 107 in step 609 is invalid.

### Step 611

Acquire and record the source path.

### Step 613

Install the storage circuit 105.

For example, enable the processing circuit 101 to control the storage circuit 105 to perform data storage operations. That is, enumerate the storage circuit 105 in the data transmission device 100 as a mass storage circuit for the first host H_1, so that the first host H_1 considers the data transmission device 100 to be a flash drive, and then transmits the data to the storage circuit 105.

### Step 615

Copy the target data TD to the storage circuit 105.

### Step 617

Wait for the completion of the copy operation.

### Step 619

Switch the host, for example, switch the control from the first host H_1 to the second host H_2. That is, the host that the user can initially control via the control device 107 and the data transmission device 101 is the first host H_1. However, in step 619, the user controls the second host H_2 rather than the first host H_1. In one embodiment, this step may be removed, that is, after the target data TD is copied to the storage circuit 105, the control right is still the first host H_1 instead of the second host H_2.

### Step 621

Copy the target data TD from the storage circuit 105 to the second host H_2. This operation can be performed automatically by the processing circuit 101 or manually after the control is switched from the first host H_1 to the second host H_2.

### Step 623

End the process of transmitting the target data TD.

The data transmission device provided by the present invention can be connected to different hosts for data transmission between the hosts without using a network. The network mentioned here can mean a communication network that is constructed by other communication devices, such as the internet or a local area network (LAN).

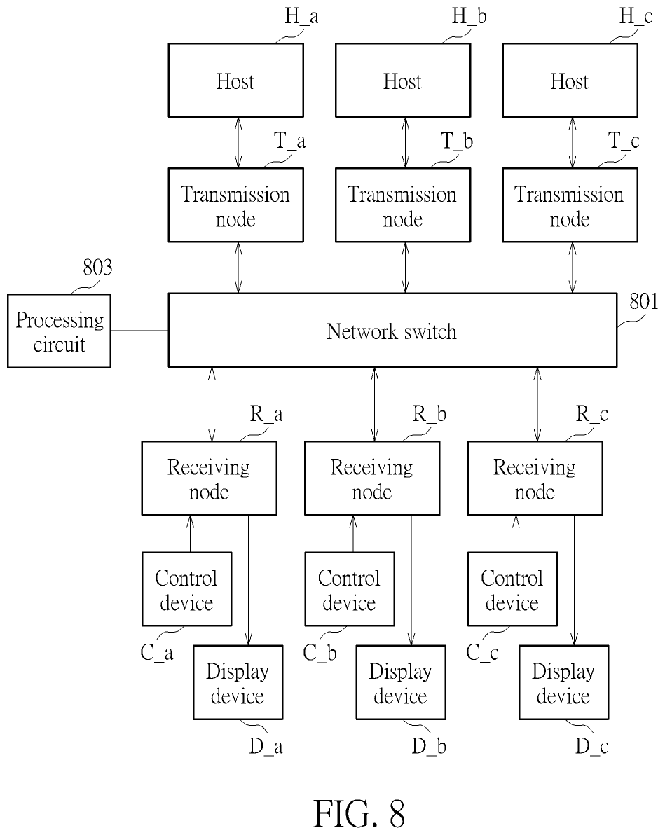

FIG. 7 and FIG. 8 are examples of practical application according to different embodiments of the present invention. Please refer to FIG. 1, FIG. 7 and FIG. 8 at the same time to understand the concept of the present invention for more clarity. In one embodiment, the data transmission device 100 in FIG. 1 is a single electronic device, and is connected to the first host H_1, the second host H_2, and the display device 109 via physical transmission lines. Also, the control device 107 can be connected to the data transmission device 100 via a physical transmission line or wirelessly. FIG. 7 shows an example of such case. As shown in FIG. 7, the data transmission device 700 is a single electronic device and comprises the same components as the data transmission device 100. In the embodiment of FIG. 7, the data transmission device 700 is connected to the hosts H_a, H_b, and H_c by physical transmission lines. Also, the hosts H_a, H_b, and H_c are respectively connected to the corresponding display devices D_a, D_b, and D_c. The control device 107 can be connected to the data transmission device 700 via a physical transmission line or wirelessly.

In another embodiment, the data transmission device provided by the present invention can also be performed via a network. In such embodiments, the data transmission device comprises a receiving node and a transmission node. Please note the node can be a device, a module, or a component. A network switch is connected between the receiving node and the transmission node, for transmitting the target data TD. The data transmission device in FIG. 8 comprises receiving nodes R_a, R_b, R_c, transmission nodes T_a, T_b, T_c, a processing circuit 803, and the storage circuit 105 (not shown) in FIG. 1. The receiving node R_a and its corresponding transmission node T_a form a data transmission group, the receiving node R_b and its corresponding transmission node T_b form a data transmission group, and the receiving node R_c and its corresponding transmission node T_c also form another data transmission group. The receiving nodes R_a, R_b, and R_c are respectively connected to the control devices C_a, C_b, C_c and the corresponding display devices D_a, D_b, D_c. The transmission nodes T_a, T_b, and T_c respectively comprises at least one port and are respectively connected to the hosts H_a, H_b, and H_c by a network cable. The network switch 801 may be a switch connected to an external network. The processing circuit 803 is configured to control the operations of the receiving nodes R_a, R_b, R_c, the transmission nodes T_a, T_b, T_c, and the network switch 801, and to control the hosts H_a, H_b, and H_c connected to the transmission nodes T_a, T_b, and T_c. The storage circuit 105 can be provided at any needed location, for example, it can be provided in one of the receiving nodes R_a, R_b, and R_c, in one of the transmission nodes T_a, T_b, and T_c, in the network switch 801, or independent from the receiving nodes R_a, R_b, R_c, the transmission nodes T_a, T_b, T_c, and the network switch 801.

The data transmission device in FIG. 8 can be used to perform the above-mentioned data transmission method. The difference between the data transmission devices in FIG. 7 and FIG. 8 is that the data transmission method in FIG. 7 can be transmitted via a single data transmission device 700, but the data transmission method in FIG. 8 is performed via multiple devices. For example, if the user copies data from the host H_a to the host H_b via the control device C_a in FIG. 8, the commands input by the user to the control device C_a are sent to the processing circuit 803 via the receiving node R_a and the network switch 801, 803. The processing circuit 803 performs the above-mentioned data transmission method via the receiving nodes T_a, T_b and the network switch 801 to copy data from the host H_a to the storage circuit 105 and then to the host H_b. The screen of the user copying data from the host H_a to the host H_b can be displayed on the display device D_a. Persons skilled in the art can understand other operations of the embodiment shown in FIG. 8 based on FIG. 8 and its related descriptions, as well as the above-mentioned embodiments, thus are omitted for brevity here. Via the architecture in FIG. 8, the user only needs to set the connection between the network switch 801 and the receiving nodes R_a, R_b and R_c, the transmission nodes T_a, T_b and T_c and the network switch 801 once. After that, any host can be connected to the transmission nodes T_a, T_b, and T_c for control, and there is no need to set the system each time when the host is connected to the network.

In view of above-mentioned embodiments, the data transmission method and the data transmission device provided by the present invention can allow different hosts to exchange data without using a network, and can use a simple architecture which allows different hosts to exchange data while using the network.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data transmission method, applied to a data transmission device connected to a first host and a second host, comprising:
(a) activating a console of the first host via a trigger operation and acquiring a source path of target data in the first host;
(b) acquiring the target data from the source path and copying the target data to a storage circuit inside or outside the data transmission device; and
(c) copying the target data from the storage circuit to the second host.

2. The data transmission method of claim 1, further comprising:
displaying a trigger region by a display device connected to the data transmission device;
wherein the trigger operation comprises: dragging the target data to the trigger region to activate the console.

3. The data transmission method of claim 2, further comprising:
if dragging of the target data is not disabled when the target data is dragged out from the trigger region after the target data is dragged to the trigger region, the step (b) does not copy the target data to the storage circuit;
if the dragging of the target data is disabled after the target data is dragged to the trigger region, the step (b) copies the target data to the storage circuit.

4. The data transmission method of claim 1, further comprising:
displaying a console window corresponding to the console by a display device connected to the first host; and
displaying the source path in the console window.

5. The data transmission method of claim 1, wherein the step (a) comprises:
activating the console and acquiring the source path by the console.

6. The data transmission method of claim 1, wherein the step (a) comprises:
displaying a console window corresponding to the console by a display device connected to the first host;
acquiring the source path without using the console; and
copying the source path and displaying the source path in the console window.

7. The data transmission method of claim 1, wherein the first host operates using an operating system, wherein the step (a), the step (b), the step (c) are performed via the operating system without any other software.

8. The data transmission method of claim 1, wherein the data transmission device is electrically connected to a console, wherein the data transmission method further comprises:
performing the trigger operation via the console; and
discontinuing control of the control device to the first host after the trigger operation is performed and before acquiring the source path.

9. The data transmission method of claim 8, wherein the data transmission device further comprises a switch circuit, wherein the data transmission method further comprises:
switching the control to the second host before the target data the is copied to the second host.

10. The data transmission method of claim 9, wherein the data transmission device further comprises a processing circuit, further comprising:
automatically copying the target data from the storage circuit to the second host via the processing circuit, after the target data is copied to the storage circuit and the control is switched to the second host by the switch circuit.

11. The data transmission method of claim 1, wherein the data transmission device is connected to a third host and comprises a processing circuit, the data transmission method further comprising:
displaying a plurality of trigger regions via a display device connected to the data transmission device, wherein the trigger operation comprises: dragging the target data to one of the trigger regions to activate the console;
automatically copying the target data from the storage circuit to the second host via the processing circuit, when the target data is dragged to the trigger region corresponding to the second host;
automatically copying the target data from the storage circuit to the third host via the processing circuit, when the target data is dragged to the trigger region corresponding to the third host.

12. The data transmission method of claim 1, wherein the step (a), the step (b), the step (c) are not performed without a network.

13. The data transmission method of claim 1, wherein the data transmission device comprises a receiving node and a transmission node, wherein a network switch is connected between the receiving node and the transmission node, for transmitting the target data.
